(19) United States
(12) Patent Application Publication
(10) Pub. No.: US 2025/0388268 A1
(43) Pub. Date: Dec. 25, 2025

(54) VEHICLE BASE STRUCTURE

(71) Applicant: TOYOTA JIDOSHA KABUSHIKI KAISHA, Toyota-shi (JP)

(72) Inventor: Isao TAKAHASHI, Toyota-shi (JP)

(73) Assignee: TOYOTA JIDOSHA KABUSHIKI KAISHA, Toyota-shi (JP)

(21) Appl. No.: 19/021,885

(22) Filed: Jan. 15, 2025

(30) Foreign Application Priority Data
Jun. 20, 2024 (JP) 2024-099356

(51) Int. Cl. B62D 21/15; B60K 1/04; B62D 27/02; B62D 29/00

(52) U.S. Cl. CPC B62D 21/157; B62D 27/023; B62D 29/00; B60K 1/04

(57) ABSTRACT

The vehicle base structure includes: a protection-subject component disposed on a lower side of a floor panel of the vehicle; a first impact absorbing member formed of a first plate member bent one or more times and having no joint; and a second impact absorbing member disposed adjacent to an outer side of the first impact absorbing member in the vehicle width direction, wherein the first impact absorbing member is surrounded by the first plate member and includes two or more closed spaces arranged in the vertical direction or the horizontal direction, and the protection-subject component and the vehicle body are fastened to the first impact absorbing member.

### CROSS-REFERENCE TO RELATED APPLICATION

This application claims priority to Japanese Patent Application No. 2024-099356 filed on Jun. 20, 2024. The disclosure of the above-identified application, including the specification, drawings, and claims, is incorporated by reference herein in its entirety.

### BACKGROUND

### 1. Technical Field

The present specification discloses a vehicle base structure including a protection-subject component that is disposed on a lower side of a floor panel of a vehicle, and an impact absorbing member that protects the protection-subject component.

### 2. Description of Related Art

Conventionally, installing a protection-subject component on a lower side of a floor panel of a vehicle has been proposed. The protection-subject component is an in-vehicle component that is expected to be protected without being damaged, even in the event of a vehicle collision. The protection-subject component is a battery, a fuel tank, or a fuel cell, for example. Disposing an impact absorbing member has been proposed, in order to protect this protection-subject component.

For example, Japanese Unexamined Patent Application Publication No. 2019-006303 (JP 2019-006303 A) discloses a structure in which a battery pack is disposed on a lower side of a floor panel. A peripheral wall of an end portion of the battery pack in a vehicle width direction has a substantially letter-B shaped cross-section, in which closed spaces extending in a vehicle front-rear direction are arrayed in an up-down direction. This peripheral wall functions as an impact absorbing member. Further, according to the technology described in JP 2019-006303 A, impact in the event of a broadside collision of the vehicle is absorbed by the peripheral wall that has the substantially letter-B shaped cross-section, and accordingly the battery can be appropriately protected.

### SUMMARY

Now, the peripheral wall in JP 2019-006303 A is manufactured by extrusion molding of a light metal (e.g., aluminum alloy). However, such extruded articles have a problem of high costs. Also, in JP 2019-006303 A, the battery pack is fastened to a rocker that is subjected to a load in the event of a broadside collision. In this case, the fastening of the battery pack and the rocker may become unfastened under the broadside impact load, and the battery pack may fall.

Accordingly, the present specification discloses a vehicle base structure that is capable of protecting a protection-subject component, which is disposed on a lower side of a floor panel, more reliably and at lower costs.

A vehicle base structure disclosed in the present specification includes
a protection-subject component that is disposed on a lower side of a floor panel of a vehicle,
a first impact absorbing member that is made up of a single first plate member that is bent one or more times and also that is seamless, and
a second impact absorbing member that is disposed adjacent to the first impact absorbing member, on an outer side of the first impact absorbing member in a vehicle width direction, in which
the first impact absorbing member includes two or more closed spaces that are surrounded by the first plate member, and that are arrayed in an up-down direction or a horizontal direction, and
the protection-subject component and a vehicle body are fastened to the first impact absorbing member.

In this case, the second impact absorbing member may be made up of a single second plate member that is bent one or more times and also that is seamless, and includes two or more closed spaces that are surrounded by the second plate member, and also that are arrayed in the up-down direction or the horizontal direction, and
the first impact absorbing member may be joined to the second impact absorbing member, and a direction of array of the two or more closed spaces of the second impact absorbing member may be the same as a direction of array of the two or more closed spaces of the first impact absorbing member.

Also, vehicle-width-direction dimensions of the first impact absorbing member and vehicle-width-direction dimensions of the second impact absorbing member may be different from each other.

Also, the first impact absorbing member and the second impact absorbing member may be arrayed in the up-down direction, and each includes two or more closed spaces that pass through in a vehicle front-rear direction, and vehicle-width-direction dimensions of the first impact absorbing member may be greater than vehicle-width-direction dimensions of the second impact absorbing member.

Also, an arrangement may be made in which the first impact absorbing member includes two closed spaces that are fashioned of the first plate member that is bent into a substantial figure-of-eight shape,
the second impact absorbing member includes two closed spaces that are fashioned of a single second plate member that is bent into a substantial figure-of-eight shape and also that is seamless,
an end portion of the first plate member and an end portion of the second plate member are welded to an intermediate portion of the first plate member and an intermediate portion of the second plate member, respectively,
the protection-subject component is a battery unit, and
each of the first plate member and the second plate member is made of an iron-based metal.

According to the vehicle base structure disclosed in the present specification, the first impact absorbing member is made up of a single first plate member, and accordingly an inexpensive material, such as an iron-based metal, can be used, for example. As a result, costs can be reduced as compared to conventional impact absorbing members. Further, both the vehicle body and the protection-subject component are fastened to the first impact absorbing member that is situated further on an inner side in the vehicle width direction than the second impact absorbing member, the protection-subject component can be effectively suppressed from falling due to impact in the event of a broadside collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of a lower part of a vehicle;

FIG. 2 is a schematic cross-sectional view of a vehicle lower portion of another example;

FIG. 3 is a schematic view showing a state of molding of the impact absorbing member;

FIG. 4 is a schematic view showing a state of deformation of the impact absorbing member at the time of side collision;

FIG. 5 is a diagram illustrating a relation between a moving stroke of an obstacle and a load absorbed by the impact absorbing member; and

FIG. 6 is a schematic diagram illustrating an example of another vehicle base structure.

### DETAILED DESCRIPTION OF EMBODIMENTS

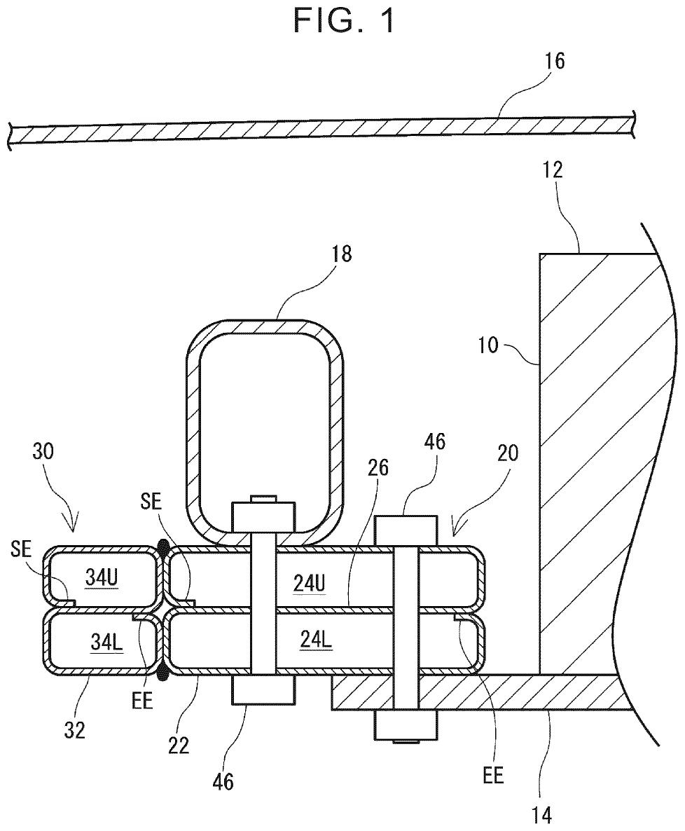

Hereinafter, a vehicle base structure will be described with reference to the drawings. FIG. 1 is a schematic cross-sectional view of a vehicle lower portion. Note that Fr, Up, Out in the drawings indicate the front, the upper, and the vehicle widthwise outer directions of the vehicle, respectively.

The vehicle is a vehicle having a large battery unit 12, and is, for example, an electrified vehicle (for example, a battery electric vehicle or a battery hybrid electric vehicle) using a motor as one of driving power sources. The battery unit 12 is a unit in which a rechargeable secondary battery is stored in a case. For example, the battery unit 12 has a flat shape having a smaller thickness dimension than a planar size. The battery unit 12 has a base plate 14 on a bottom surface thereof. The base plate 14 extends in a flange shape to the outside in the vehicle width direction from the main body of the battery unit 12. The battery unit 12 is fastened to another member in the flange-shaped portion. Since the battery unit 12 is a high-voltage component, it is required to be protected without being damaged even in the event of a vehicle collision. In this specification, a structure in which the battery unit 12 is protected as the protection-subject component 10 will be described.

Side frames 18 constituting a vehicle body are arranged on both left and right sides of the battery unit 12. The side frame 18 is a skeletal member of the vehicle and extends in the vehicle front-rear direction. The side frame 18 is, for example, a rectangular tubular member having a rectangular cross section. Further, a frame member called a rocker (not shown) is disposed outside the side frame 18 in the vehicle width direction. The floor panel 16 is located above the side frame 18 and the battery unit 12. Both ends of the side frame 18 in the vehicle width direction are joined to, for example, the floor panel 16.

Here, in order to suppress an impact input to the battery unit 12 when an obstacle collides with a side portion of the vehicle, the impact absorbing members 20 and 30 are disposed on the vehicle width direction outer side of the battery unit 12. In the following description, the “impact absorbing member” is referred to as an “EA member”.

EA members 20 and 30 are members that consume collision energy and protect the protection-subject component 10 by actively collapsing when the collision energy is inputted. The first EA member 20 is disposed on the vehicle width direction outer side of the battery unit 12, and the second EA member 30 is disposed on the vehicle width direction outer side of the first EA member 20. Each of the first EA member 20 and the second EA member 30 has two closed spaces 24U, 24L, 34U, 34L arranged vertically. When the vehicle collides, the plurality of closed space 24U, 24L, 34U, 34L collapse, and thus the impact energy is absorbed.

The first EA member 20 and the second EA member 30 have substantially the same configuration, but the second EA member 30, that is, EA member located on the outer side in the vehicle width direction has a smaller vehicle-width-direction dimensions than the first EA member 20. The side frame 18 and the battery unit 12 are fastened to the first EA member 20 by bolts 46. The first EA member 20 and the second EA member 30 are welded together. The black-and-ellipse in FIG. 1 shows the weld points of the first EA member 20 and the second EA member 30.

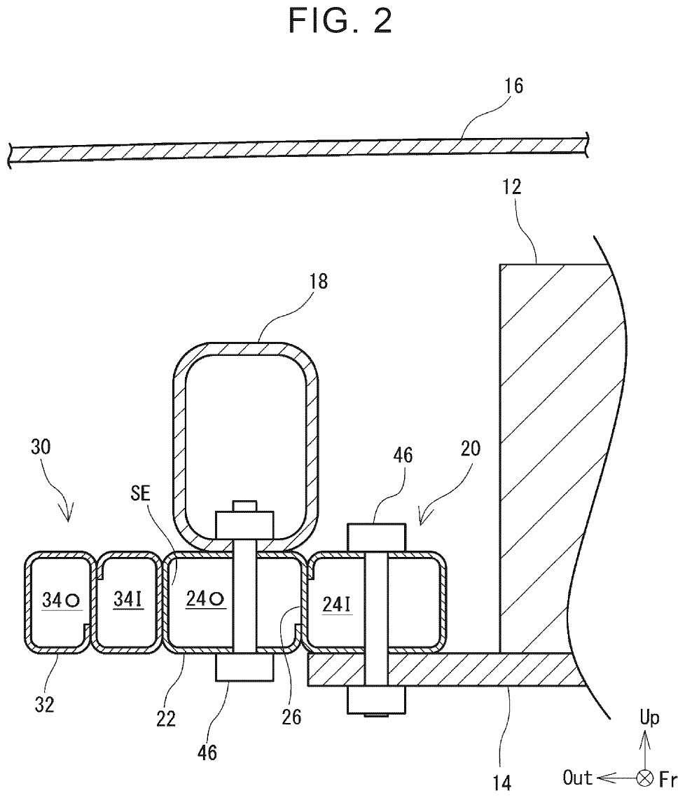

In FIG. 1, each of the two EA members 20 and 30 has a closed space 24U, 24L, 34U, 34L arranged vertically. However, as shown in FIG. 2, each of the two EA members 20 and 30 may have a closed space 241, 240, 341, 340 arranged in the left-right direction. Note that, in the following explanation, when the position of the closed space is not distinguished, the subscript U, L, I, O is omitted, and is expressed as “closed space 24” or “closed space 34”.

Here, as is clear from FIGS. 1 and 2, the first EA member 20 is composed of the first plate member 22 without a joint, and the second EA member 30 is composed of the second plate member 32 without a joint.

Each of the first plate member 22 and the second plate member 32 is made of an iron-based metal.

More specifically, the first EA member 20 is formed by bending the first plate member 22 into the figure-of-eight. In the exemplary embodiment of FIG. 1, the first plate member 22 is advanced clockwise from the starting end SE to return to the starting end SE to form a first loop surrounding the upper closed space 24U, and thereafter, is advanced counterclockwise to form a second loop surrounding the lower closed space 24L. The intermediate part of the first plate member 22 serves as a partition wall 26 that separates the upper closed space 24U and the lower closed space 24L. Similarly, the second EA member 30 is formed by bending the second plate member 32 into the shape of figure-of-eight.

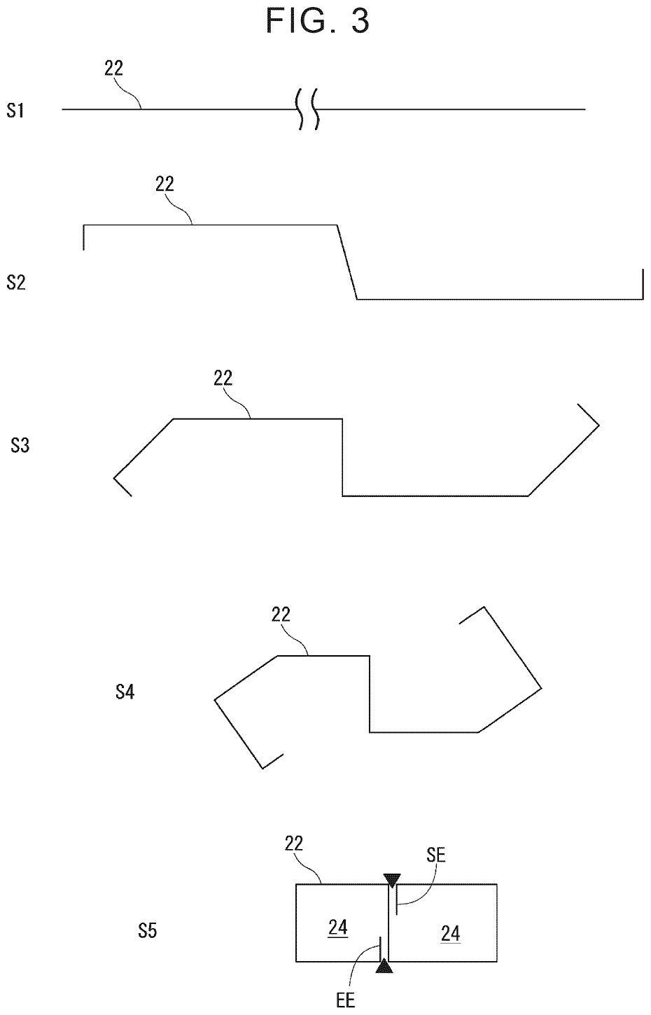

The first EA member 20 and the second EA member 30 are manufactured by rolling. FIG. 3 is a schematic view showing a state of roll processing. Rolling is a process of stepwise bending a plate member using a tool called a roll (not shown). In the present embodiment, the first plate member 22 constituting the first EA member 20 is provided to the rolling process in a complete flat plate as shown in S1 of FIG. 3. In the rolling process, the flat plate is gradually bent from S2 as shown in S5. Finally, the first plate member 22 has a substantially figure-of-eight shape in which two closed spaces 24 are arranged. In this condition, the starting end SE and the ending end EE of the first plate member 22 are welded to the intermediate part of the first plate member 22 adjacent to each other. The black triangle in FIG. 3 indicates the welding point. Although the first EA member 20 is exemplified here, the second EA member 30 is manufactured in the same manner.

Conventionally, such an EA member is often manufactured by extrusion using a light metal (e.g., aluminum) as a material. In the extrusion process, an EA member in which a plurality of closed spaces are seamlessly connected is obtained. However, in the case of such a light metal extruded part, the price is high, which leads to an increase in the vehicle price.

On the other hand, in the present embodiment, as described above, EA members 20 and 30 are manufactured by rolling the plate members 22 and 32 made of an inexpensive ferrous metal. As a result, the component cost can be significantly reduced as compared with the case where a light metal extruded component is used.

Further, in the present embodiment, the first EA member 20 is composed of a first plate member 22 having no joint. Accordingly, the first EA member 20 is less likely to be broken even when a colliding load is applied. That is, when the first EA member 20 is configured by combining a plurality of plate members, the strength is likely to decrease at the joint of the two plate members, and breakage is likely to occur at the joint when the first EA member is subjected to an impact load. When the first EA member 20 is broken, the impact load cannot be sufficiently absorbed. In addition, depending on the breakage point, the battery unit 12 may be separated from the side frame 18 and may fall off from the vehicle. On the other hand, when the first EA member 20 is formed of the first plate member 22 having no joint, such breakage of the first EA member 20 can be prevented, so that the impact load can be sufficiently absorbed and the battery unit 12 can be prevented from falling off. Further, since the second EA member 30 is also constituted by one second plate member 32 having no joint, it is possible to sufficiently absorb the impact load while preventing breakage of the second EA member 30.

In this embodiment, both the battery unit 12 and the side frame 18 are fastened to the first EA member 20. With this configuration, it is possible to effectively prevent the battery unit 12 from falling off. That is, the first EA member 20 is located on the vehicle-width-direction inner side of the second EA member 30. Since a large collision load is absorbed by the second EA member 30, the collision load inputted to the first EA member 20 is small. Consequently, deformation of the first EA member 20 is suppressed, and fastening of the first EA member 20 to the side frame 18 and fastening of the first EA member 20 to the battery unit 12 are maintained without being released. As a result, the battery unit 12 does not fall off from the vehicle.

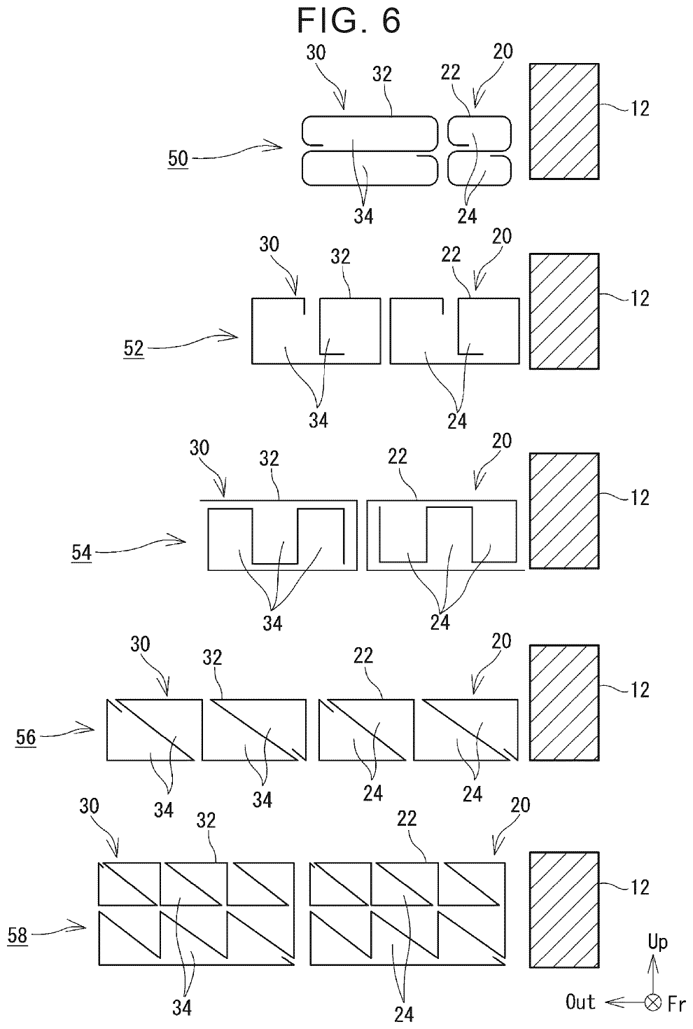

Furthermore, the first EA member 20 and the second EA member 30 are each formed by bending a single plate member 22, 32 into a figure-of-eight shape. Thus, the overlapping portions between the plate members can be reduced. That is, when EA member is formed of a single plate member, it is conceivable to bend the plate member so as to pass through the same side twice as in the structure 52 of FIG. 6. However, since a portion where the plate members overlap and a portion where the plate members do not overlap each other occur, the strength of one of EA members 20 and 30 varies greatly. As a result, when the collision load is applied, the collapse of the closed spaces 24 and 34 becomes uneven, and the control of the mode of the collision energy absorption becomes complicated. On the other hand, in the present embodiment, the overlapping of the plate members 22 and 32 is limited to the starting end SE and the ending end EE of the plate members 22 and 32, and in most parts, the plate members 22 and 32 do not overlap. Consequently, in one of EA members 20 and 30, the variation in strength can be suppressed to be small, and the collapse manner of the closed spaces 24 and 34 can be made uniform. Thus, the mode of collision energy absorption can be controlled more appropriately.

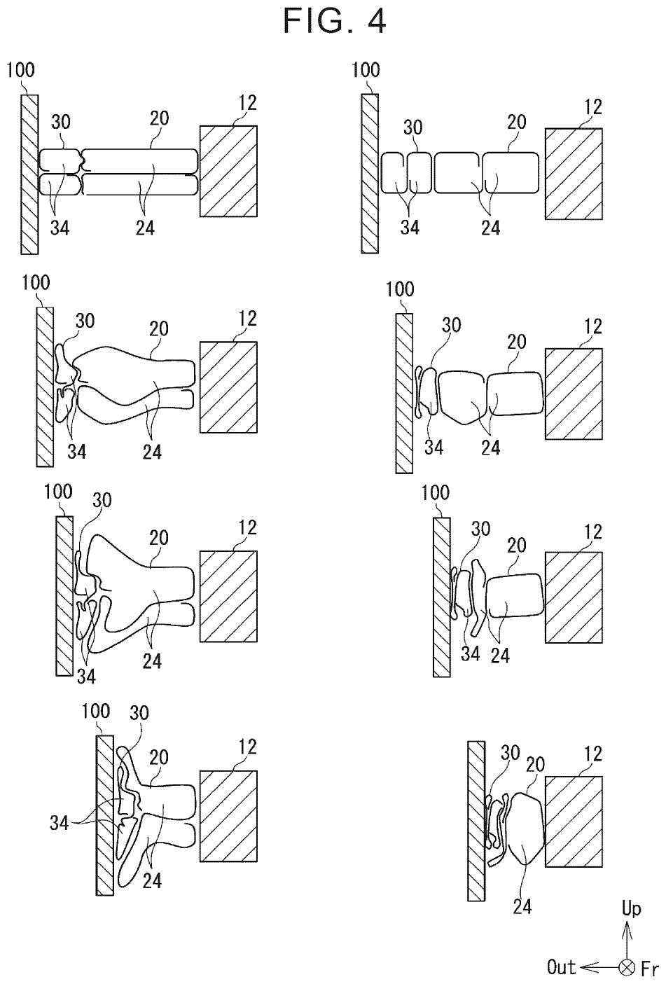

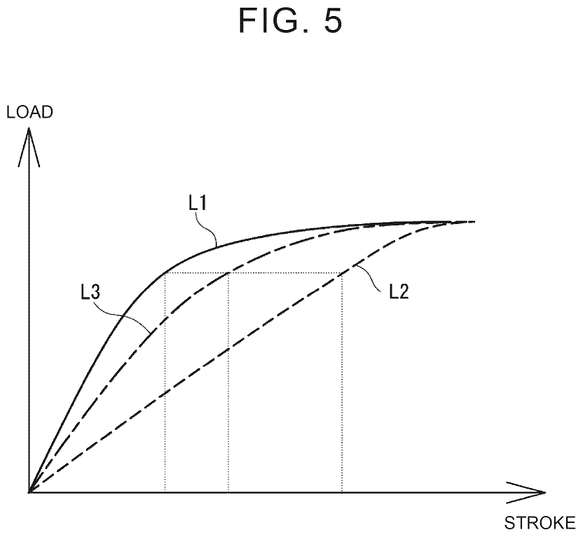

As described above, the plurality of closed spaces 24 and 34 may be arranged vertically as shown in FIG. 1, or may be arranged horizontally as shown in FIG. 2. However, the mode of absorption of the collision energy differs depending on the direction of array of the closed spaces 24 and 34. Therefore, the arrangement of the closed spaces may be selected according to the required absorption mode. This will be described with reference to FIGS. 4 and 5. FIG. 4 is a schematic view showing a state of deformation of EA members 20 and 30 at the time of side collision. FIG. 5 is a diagram illustrating a relation between a moving stroke of the obstacle 100 and a load absorbed by EA members 20 and 30.

In FIG. 4, the left column shows a case where the closed spaces 24 and 34 are arranged vertically (hereinafter, referred to as “vertical arrangement type”), and the right column shows a case where the closed spaces 24 and 34 are arranged horizontally (hereinafter, referred to as “horizontal arrangement type”). Further, in FIG. 4, time has elapsed from the top to the bottom of the drawing. As shown in the left column of FIG. 4, in the case of the vertical arrangement type, three walls extending in the horizontal direction (that is, the walls of the upper surface and the walls of the bottom surface of the closed spaces 24 and 34) are arranged vertically. Therefore, the vertically aligned type exhibits a high bearing capacity against a load in the horizontal direction. In the case of the vertical arrangement type, the load is easily transmitted to all the closed spaces 24 and 34. As a result, a large load can be absorbed immediately after the obstacle 100 collides. The solid line L1 in FIG. 5 indicates the state of the load absorbing in the vertical arrangement type. As shown in FIG. 5, in the case of the vertical arrangement type, since a large load can be absorbed with a small stroke, the load input to the battery unit 12 can be effectively prevented, and the battery unit 12 can be protected more reliably.

In the case of the side-by-side type, as shown in the right column of FIG. 4, only two horizontally extending walls are arranged one above the other. Therefore, in the case of the side-by-side type, the load is less likely to be transmitted to the inside in the vehicle width direction than in the case of the side-by-side type. Compared with the vertical arrangement type, the horizontal arrangement type has a slower rise of load. The dashed line L2 in FIG. 5 indicates the state of load absorbing in the side-by-side type. As shown in FIG. 5, in the case of the side-by-side type, the load gradually rises. Such a side-by-side type is suitable, for example, for a light-weight vehicle. When a lightweight vehicle receives a large load momentarily, the lightweight vehicle cannot receive the load on the entire vehicle, and may fall over. Therefore, in the light-weight vehicles, the side-by-side EA members 20 and 30 may be employed to absorb the load with a long stroke instead of suppressing the instantaneous load to be small.

Further, in the side-by-side EA members 20 and 30, as shown in FIG. 4, after one of the closed spaces 24 and 34 is almost completely collapsed, the subsequent closed spaces 24 and 34 are collapsed. In other words, in the case of the side-by-side type, the plurality of closed spaces 24 and 34 are regularly collapsed in order compared with the case of the side-by-side type. Therefore, it is easy to grasp the mode of collision energy absorption. As a consequence, in the case of the side-by-side type, it is easy to control the progress of the breakage of EA members 20 and 30 at the time of the side collision.

As is obvious from the above explanation, in the present embodiment, EA members 20 and 30 that protect the battery unit 12 from the impact load are formed of single plate members 22 and 32 made of an iron-based metal. With such a configuration, the performance of EA members 20 and 30 can be maintained, and the cost can be greatly reduced. In addition, both the battery unit 12 and the side frame 18 are fastened to the first EA member 20 located on the vehicle-width-direction inner side. This effectively prevents the battery unit 12 from separating from the side frame 18 and thus the battery unit 12 from the vehicle.

Note that the configuration described above is an example, and other configurations may be changed as appropriate as long as the configuration described in claim 1 is provided. For example, in the above explanation, the vehicle-width-direction dimensions of the first EA member 20 located on the vehicle width direction inner side is made larger than the vehicle-width-direction dimensions of the second EA member 30. However, such dimensions may be varied as appropriate. For example, the vehicle-width-direction dimensions of the first EA member 20 and the second EA member 30 may be the same as each other. In addition, as in the configuration 50 of FIG. 6, the second EA member 30 disposed on the vehicle-width-direction outer side may be wider than the first EA member 20. Note that EA member having a smaller width has a faster rise in load than EA member having a larger width. For example, in the configuration 50, the relation between the load and the stroke is shown by a dashed-dotted line L3 in FIG. 5.

Further, as long as EA members 20 and 30 have two or more closed spaces 24 and 34 arranged in the up-down direction or the left-right direction, the configuration thereof may be changed as appropriate. For example, as in the structure 52 of FIG. 6, the plate members 22 and 32 may be bent in a form other than an eight-shape. Also, as in the structure 54 of FIG. 6, one EA member 20, 30 may have three or more closed spaces 24, 34. In the case of the structure 54, the plate members 22 and 32 pass through one side two or more times. Therefore, in the case of the structure 54, the sides constituting the plurality of closed spaces 24 and 34 are composed of one plate and the sides in which two plates overlap each other. In this case, variations in strength occur depending on the portions of EA members 20 and 30. However, the structure 54 can be said to be sufficiently useful in a case where the merit of increasing the number of the closed spaces 24 and 34 is larger than the demerit due to the variation in the strength. Further, the disadvantage of the variation in strength can be alleviated by arranging two or more EA members 20 and 30 in an attitude of 180 degrees.

Although the case where the closed spaces 24 and 34 are substantially rectangular is exemplified, the shapes of the closed spaces 24 and 34 may be changed as appropriate. For example, as shown in the configuration 56 of FIG. 6, EA members 20 and 30 may have a configuration in which closed spaces 24 and 34 having substantially triangular shapes are arranged consecutively. In this case, the plate members 22 and 32 advance in a clockwise direction (or counterclockwise) to form one triangle, and then advance in a counterclockwise direction (or clockwise) to form another triangle. That is, each time one triangle is completed, the plate members 22 and 32 continuously form a plurality of triangles while reversing the traveling direction. With this configuration, it is possible to form three or more closed spaces 24 and 34 while avoiding the overlapping of the plate members 22 and 32.

The plurality of closed spaces 24 and 34 are not limited to one direction, and may be arranged in an array in two vertical and horizontal directions. For example, as illustrated in the structure 58 of FIG. 6, the plurality of closed spaces 24 and 34 may be arranged in the up-down direction and the left-right direction. Further, in the above explanation, both of the first EA member 20 and the second EA member 30 are roll-molded products made of an iron-based metal. However, as long as at least the first EA member 20 is configured by bending one plate member 22 without a joint, the second EA member 30 may be an extruded article or may be configured by joining a plurality of components. In addition, the above description has been given by exemplifying that the protection-subject component 10 protected by EA members 20 and 30 is the battery unit 12. However, the protection-subject component 10 may be another component as long as it is a component disposed below the floor panel 16 of the vehicle. For example, the protection-subject component 10 may be a fuel tank or a fuel cell.

What is claimed is:

1. A vehicle base structure, comprising:
a protection-subject component that is disposed on a lower side of a floor panel of a vehicle;
a first impact absorbing member that is made up of a single first plate member that is bent one or more times and also that is seamless; and
a second impact absorbing member that is disposed adjacent to the first impact absorbing member, on an outer side of the first impact absorbing member in a vehicle width direction, wherein
the first impact absorbing member includes two or more closed spaces that are surrounded by the first plate member, and that are arrayed in an up-down direction or a horizontal direction, and
the protection-subject component and a vehicle body are fastened to the first impact absorbing member.

2. The vehicle base structure according to claim 1, wherein
the second impact absorbing member is made up of a single second plate member that is bent one or more times and also that is seamless, and includes two or more closed spaces that are surrounded by the second plate member, and also that are arrayed in the up-down direction or the horizontal direction,
the first impact absorbing member is joined to the second impact absorbing member, and
a direction of array of the two or more closed spaces of the second impact absorbing member is the same as a direction of array of the two or more closed spaces of the first impact absorbing member.

3. The vehicle base structure according to claim 2, wherein vehicle-width-direction dimensions of the first impact absorbing member and vehicle-width-direction dimensions of the second impact absorbing member are different from each other.

4. The vehicle base structure according to claim 3, wherein
the first impact absorbing member and the second impact absorbing member are arrayed in the up-down direction, and each includes two or more closed spaces that pass through in a vehicle front-rear direction, and
vehicle-width-direction dimensions of the first impact absorbing member are greater than vehicle-width-direction dimensions of the second impact absorbing member.

5. The vehicle base structure according to claim 1, wherein
the first impact absorbing member includes two closed spaces that are fashioned of the first plate member that is bent into a substantial figure-of-eight shape,
the second impact absorbing member includes two closed spaces that are fashioned of a single second plate member that is bent into a substantial figure-of-eight shape and also that is seamless,
an end portion of the first plate member and an end portion of the second plate member are welded to an intermediate portion of the first plate member and an intermediate portion of the second plate member, respectively,
the protection-subject component is a battery unit, and
each of the first plate member and the second plate member is made of an iron-based metal.
